(19) United States
(12) Patent Application Publication
(10) Pub. No.: US 2015/0088548 A1
(43) Pub. Date: Mar. 26, 2015

(54) System and Method for Determining a Sufficiency of Data Entry in an Electronic Health Record

(71) Applicant: Intelligent Medical Objects, Inc., Northbrook, IL (US)

(72) Inventors: Regis Charlot, Lake Bluff, IL (US); John Ennis, Libertyville, IL (US); Frank Naeymi-Rad, Libertyville, IL (US); David Haines, Arlington Heights, IL (US); Jose Maldonado, Chicago, IL (US); Fred Masarie, Portland, OR (US)

(21) Appl. No.: 14/444,163

(22) Filed: Jul. 28, 2014

Related U.S. Application Data
(60) Provisional application No. 61/882,720, filed on Sep. 26, 2013.

(51) Int. Cl. G06F 19/00

(52) U.S. Cl. CPC G06F 19/322
USPC 705/3

(57) ABSTRACT

A method for determining a sufficiency of data entry in an electronic health record includes: receiving a packet of input data from a user, the input data reflecting patient problem, history, or diagnosis information; linking data elements in the packet with interface terminology data elements; mapping the interface terminology data elements corresponding to the codified data elements to data elements in a code set; sending the mapped data elements in the sample code set to a DRG encoder or DRG web service; and receiving zero or more DRGs correspond to the mapped data elements. The results of the receiving step then are conveyed back to the user so that the user may know whether sufficient data has been entered or whether additional details are necessary.

This application claims the benefit of priority from U.S. provisional application 61/882,720, filed Sep. 26, 2013.

### BACKGROUND OF THE INVENTION

Inpatient and ambulatory medical care is governed internally by classification of the patient's condition within one of approximately 500 Diagnosis-Related Groupers (DRGs). It is important for a practitioner to accurately and completely record the patient's disease severity by capturing primary and secondary diagnosis, not just to obtain as complete a medical picture as possible for the patient, but because most insurance companies will provide coverage only for conditions and treatments related to the DRG that captures a patient hospital admission.

Traditionally, a practitioner would evaluate the patient and generate medical notes that then would be placed in a patient's paper or electronic medical record. Those notes then would be transmitted to a medical records department of the hospital or other care provider, which would generate codes relating to the user's admission, which could relate to a diagnosis or procedure. There may be several different code sets or terminologies that get applied to the patient's records. For example, codes from the International Classification of Diseases, Ninth Revision, Clinical Modification (ICD-9-CM) may be used to document the diagnosis(es) that were performed for billing purposes.

Different healthcare ontologies may have unique features and purposes. For example, the American Medical Association (AMA)'s Current Procedural Terminology (CPT) codeset captures procedures from an administrative and financial standpoint, Intelligent Medical Objects's ProblemIT clinical diagnosis terminology captures the care provider clinical intent from a clinical terminology standpoint, while, Logical Observation Identifiers Names and Codes (referred to under the trademark “LOINC”), is used for laboratory results from a terminology reference standpoint.

Terms related to terminology include: Medical Ontologies, Medical Administrative code sets; Clinical Interface Terminologies; and Clinical Reference terminologies.

Administrative code sets may be designed to support administrative functions of healthcare, such as claim management, reimbursement and other secondary data aggregation. Common examples are the International Classification of Diseases referred to as ICD-9-CM and AMA's Current Procedural Terminology, which is referred to via the trademark CPT. Each system may be different, e.g., ICD-9-CM's purpose is to aggregate, group, and classify conditions, whereas CPT is used for reporting medical services and procedures.

A reference terminology may be considered a “concept-based, controlled medical terminology.” The Systematized Nomenclature of Medicine Clinical Terms (referred to under the trademark “SNOMED CT”) is an example of this kind of terminology. It maintains a common reference point in the healthcare industry. Reference terminologies also identify relationships between their concepts. Relationships can be hierarchically defined, such as a parent/child relationship. The reference terminology contains concept A and concept B, with a defined relationship of B as a child of A. SNOMED CT includes concepts such as heart disease and heart valve disorder, and their defined relationship identifies heart valve disorder as a child of heart disease.

Reference terminologies also include codes sets that have been developed to encode specific clinical entities involved in clinical work flow, such as SNOMED CT, LOINC and RxNorm. Such code sets have been developed to allow for meaningful electronic exchange and aggregation of clinical data for better patient care. For example, sending a laboratory test result using LOINC facilitates the receiving facility's ability to understand the result sent and make appropriate treatment choices based upon the laboratory result.

Reference terminology may allow healthcare systems to get value from clinical data coded at the point of care. In general, reference terms may be useful for decision support and aggregate reporting and may be more general than the highly detailed descriptions of actual patient conditions. For example, one patient may have severe calcific aortic stenosis and another might have mild aortic insufficiency; however, a healthcare enterprise might be interested in finding all patients with aortic valve disease. The reference terminology creates links between “medical concepts” that allow these types of data queries.

Once the patient record is codified with the relevant terminologies, the medical record department then may generate a patient insurance claim record including a Disease Related Grouper (DRG) code categorizing the patient's condition in a broader category. The DRG may be generated by an encoder, which may analyze the codes in the record and determine which DRG is most applicable.

One problem with this process is that the initial practitioner may not enter sufficient data for the medical record department/the encoder to determine which DRG best applies (other than an “invalid” or “ungroupable” DRG, which is what may be assigned if the encoder does not have sufficient information).

One reason for this relative lack of information is that activity data may be subject to interpretation, creating a gap between intended clinical visit diagnosis and the appropriate DRG code for building a reimbursement claim. For example, each DRG typically is weighted in order to express a severity of the condition to which it relates. In one aspect, each major DRG category may include three separate DRGs, e.g., one with major complication or comorbidity, one with (non-major) complication or comorbidity, and one without complication or comorbidity, major or otherwise. For two related situations, a higher severity DRG weight may correspond to a longer hospital stay and/or a larger reimbursement. However, the practitioner may not provide sufficient information to determine the proper severity of the situation and, as such, to determine which DRG code applies.

Another problem that may exist is that a practitioner may record detailed information reflecting his or her clinical intent, but that intent may not translate into an appropriate DRG.

In either case, it may be necessary to go back to the practitioner, potentially in a busy, inconvenient patient setting environment, to seek clarification or additional material, which is inefficient for both the practitioner and the medical record department personnel.

As with the various terminologies, there also are various DRGs from which a health care provider may select. As an alternative to the approximately 500 standard DRGs, Medicare Severity DRGs (MS-DRGs) may be used for Medicare cases. There also are Refined DRGs (R-DRG), All Patient DRGs (AP-DRG), All Patient Refined DRGs (APR-DRG), International-Refined DRGs (IR-DRG), Severity DRGs (S-DRG), and All Patient, Severity-Adjusted DRGs (APS-DRG).

The same problem discussed above may apply similarly to these DRGs (including present and future revisions), and to other DRGs that may be created in the future. As used herein, the phrase “DRG” or “Diagnosis-Related Group” may refer to any or all of these variations.

What are needed are a system and method that address one or more of the issues presented above.

### BRIEF SUMMARY OF THE INVENTION

In one aspect, a method for determining a sufficiency of data entry in an electronic health record may include the steps of: receiving a packet of input data from a user, the input data reflecting patient problem, history, or diagnosis information; codifying data elements in the packet with interface terminology data elements; mapping the interface terminology data elements corresponding to the codified data elements to data elements in a sample code set, e.g., an ICD-9-CM code set; processing the mapped data elements in the sample code set through a DRG encoder; and determining whether one or more DRGs correspond to the mapped data elements.

The processing step may include the steps of generating each permutation of the mapped data elements in the sample code set and processing a plurality of the permutations through the DRG encoder. In addition, the method may include processing fewer than all of the permutations through the DRG encoder, e.g., by determining a subset of permutations that is more likely or less likely to result in a DRG match or by determining potential primary and secondary diagnosis based on the mapped data elements and then analyzing the permutations of that significantly reduced subset.

The method also may include the step of reporting results of the determining step to the user, who may be a clinician evaluating a patient. This reporting step may include providing the user with an identification of the corresponding DRGs. Alternatively, the reporting step may include not providing the user with an identification of the corresponding DRGs but instead providing the user with an indicator as to whether one or more DRGs are returned by the encoder. Still further, the method may comprise alerting the user if the packet of input data is insufficient to yield at least one DRG in the processing step.

The interface terminology data elements may capture a clinical intent of the user, and there may be a many-to-many relationship between interface terminology data elements and DRGs.

In addition, at least one of the codifying, mapping, and processing steps may be executed by a remotely-located or locally-located software-as-a-service solution.

Features and advantages are described in the following description, with reference to the accompanying drawings.

### BRIEF DESCRIPTION OF THE SEVERAL VIEWS OF THE DRAWINGS

FIG. 1 is a depiction of the medical business processes linking interface terminology and data flow in a medical environment.

FIG. 2 is a representation illustrating one example of the relationship between concepts and descriptions within an interface terminology and external codes linked to the terminology.

FIGS. 3A-3E (collectively “FIG. 3”) are a conceptual database schema diagram depicting the relationship between elements of an interface terminology and the mapping to elements of an external code set or vocabulary.

FIGS. 4A-4C (collectively “FIG. 4”) are a database entity relationship diagram illustrating one example of interface terminology including an external code set.

FIG. 5 is a screenshot of multiple drop-down menus for receiving user input when mapping concepts.

FIG. 6 is an example of a plurality of interface terminology concepts mapping to one or more respective external codes.

FIG. 7 is an exemplary flow chart of a method of data sufficiency verification.

FIG. 8 is an exemplary flow chart of a variation of the method of data sufficiency verification shown in FIG. 1.

FIG. 9 is an exemplary flow chart of a variation of the method of data sufficiency verification shown in FIGS. 1 and 2.

FIG. 10 is a schematic of a system for verifying the sufficiency of data input and for post-processing of the input data.

### DETAILED DESCRIPTION

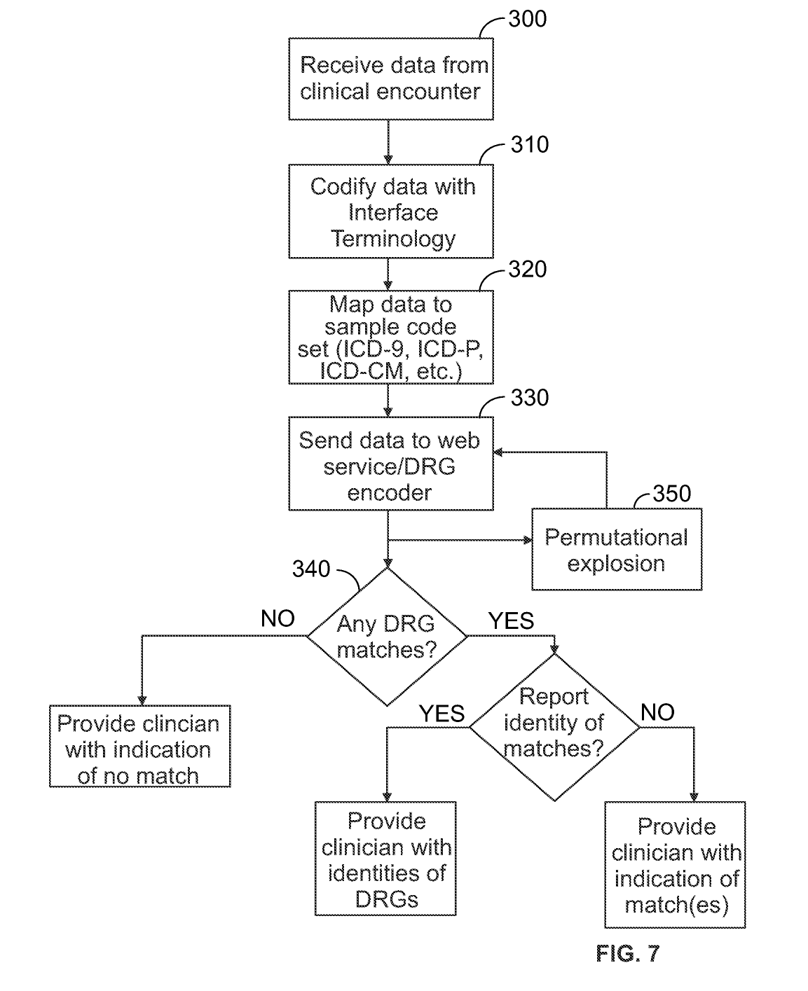

A system and method shown in FIGS. 7-10 to capture inpatient or ambulatory patient data, determine at the time of initial data entry whether sufficient data has been entered to indicate one or more potential DRGs, and present the user with that determination.

In one aspect, the system may analyze the input data in a medical record and codify it with one or more elements reflecting one or more code sets, such as administrative or reference terminology sets 320. In order to determine whether sufficient information has been added to generate a DRG, the system may rely upon a single terminology or class of terminologies, e.g., ICD-9-CM [vols. 1 and 2] diagnoses, ICD-9-CM Volume 3 Inpatient Procedures [a.k.a. ICD-P], and/or ICD-10-CM, and ICD-10-Procedure Coding System (ICD-10-PCS). This terminology or class of terminologies may be referred to herein as a sample code set.

The system also may codify the record with an interface terminology code set 310, which may be a link between what a clinician wants to say and what the terminology can capture, and which also may be a suite of vocabulary products that help institutions capture clinical information and intent.

More information about interface terminology may be found in the co-owned U.S. publication 2012/0179696, titled “System and Process for Concept Tagging and Content Retrieval.” More information about one manner of linking administrative, clinical, and reference terminologies with one another and with a common interface terminology may be found in the commonly-owned U.S. application Ser. No. 13/660,512, titled “Method and System for Concept-Based Terminology Management.” The contents of both applications are incorporated herein by reference.

### Concept-Based Terminology

Many terminologies are required in today's healthcare environment, including one or more administrative code sets, one or more clinical code sets, and one or more reference terminologies. This may result in multiple coding systems being used in a single patient's electronic record and may create an environment where the disparate systems must exchange as well as understand information to provide an effective, integrated healthcare system. Over the life of the patient, modifications or updates may be made to one or more of the terminology groups, further compounding the complexity and need for a comprehensive system configured to recognize multiple terminologies and to communicate those to other terminologies.

In order to provide patient-centered care, providers should be able to document patient care with sufficient clinical specificity. Sound EHR practices allow providers to engage in a patient's care delivery effectively because electronic documentation supports patient-centered care in multiple fashions, most notably for decision-support capabilities and the exchange of data across providers and settings. An important aspect of patient-centered care is having access to dependable data in order to make sound decisions. Accurate and reliable information in an electronic format requires all stakeholders to be engaged with the record. However, forcing a physician to document in administrative terms may be uncomfortable and disruptive.

As described herein, interface terminology may bridge the gap between information that is in the clinical user's mind, i.e., the clinical intent, and information that can be interpreted by computer applications. Interface terminology may help clinicians find the right diagnosis and procedure terms to document and code more comprehensively and accurately within their normal workflow.

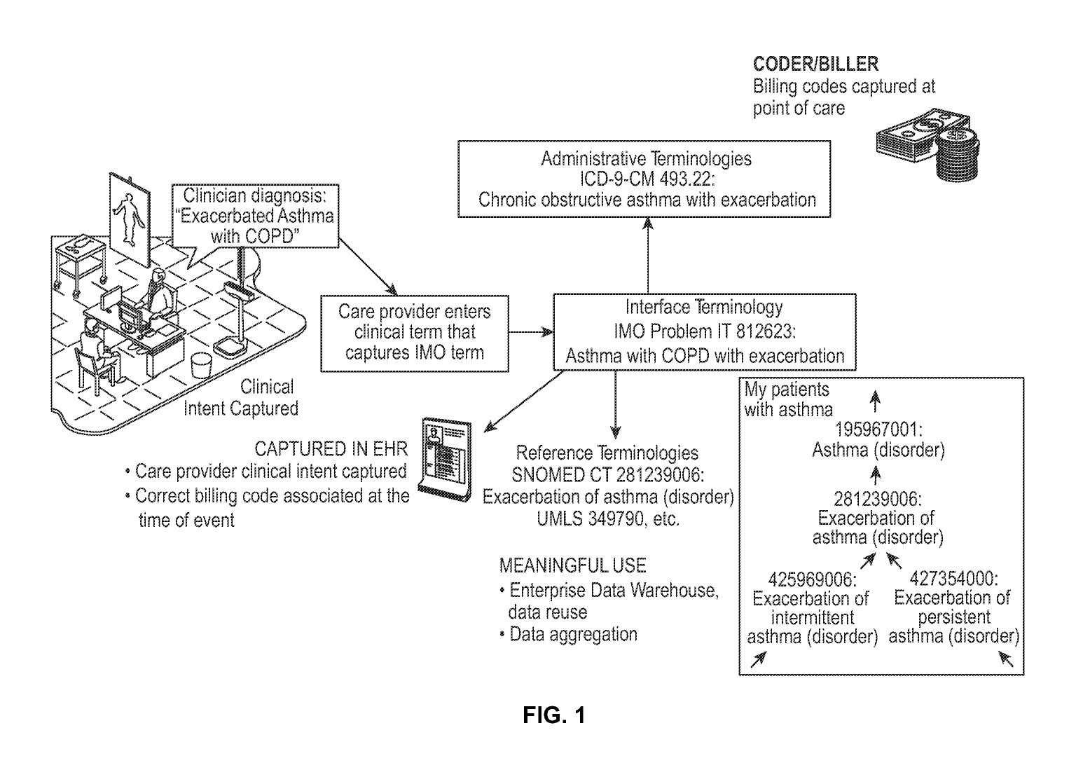

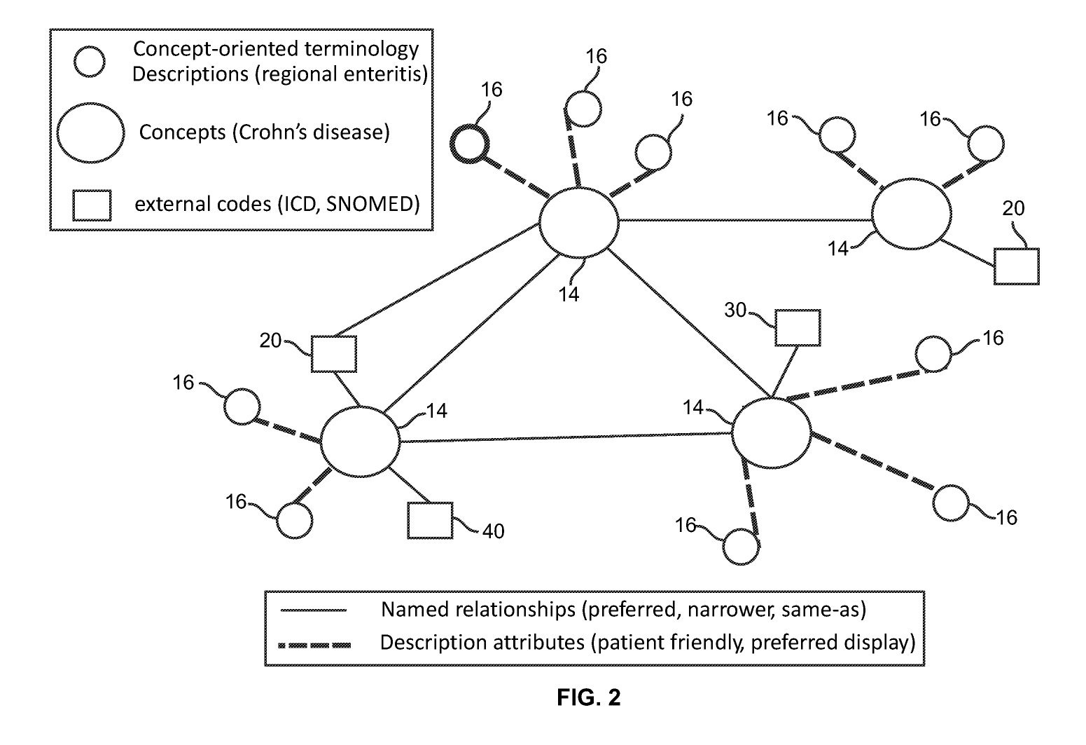

As shown in FIG. 1 and FIG. 2, a clinician's intent may be entered into a system. Via external links to the interface terminology 10, that clinical intent may be linked to one or more external codes sets, e.g., administrative terminologies 20 such as ICD-9-CM, reference terminologies 30 such as SNOMED CT, and clinical terminologies (not shown) Linking to the administrative terminologies 20 may allow for more efficient and accurate completion of various administrative tasks, such as billing. Linking to a reference terminology 30 may allow for meaningful use, such as patient data aggregation and analysis. In addition, via the interface terminology 10, the patient's EHR 50 may be populated with an entry reflecting the clinician's intent, which may lead to more accurate and thorough treatment, proper billing codes for more precise billing, and clinical data for improved research and analysis.

Terminology is important in many fields, particularly in the medical field, where very specific information may be required to provide a proper diagnosis for evaluation and treatment or a complete medical record for accurate analysis of a patient's history. To this end, medical records are faced with two competing problems: without sufficient specificity, the user may not be able to record accurately what is needed for quality patient care and may be “forced” to say something that is not quite correct. Conversely, the higher the degree of granularity or specificity, i.e., the greater the number of concepts, the larger and more unwieldy the system may become. This also may lead to unnecessary variation, where multiple concept entries exist for what fairly should be considered the same concept.

The method and system of applying the interface terminology 10 described herein may manage these competing interests by employing a set of clinically relevant terms mapped to one or more other code sets, which may include internal or external code sets and further may include industry standard administrative and clinical code sets and reference terminologies. Clinically relevant terms capture granularity and clinical intent in the documentation.

Interface terminology may include multiple components, including: Domains, Concepts, Descriptions, and Words. As discussed below, there may be relationships among elements within each of these components, as well as between elements within each component, which may be described as granularity.

### Domains

A domain 112 may be the uppermost level of the hierarchy. Each domain may be a container for one or more concepts.

Domains may include, e.g., problems, procedures, diagnoses, medications, allergies, family history, observations, etc.

### Concepts

Concepts 114 may be one step down from domains and may be considered containers for descriptions. A concept may define a clinical finding and may be a fully, well-defined expression of clinical intent. It may be unambiguously defined and may reside within a single domain.

A concept 14 may be a coded entity with unique semantics. While concepts 14 may reside higher up in the order of terminology specificity, concepts preferably are specific enough to provide accurate, unique terminology for a user.

Adding a concept may require creating a concept description 16 (more specific) and domain (more general) for the concept. The concept description 16 may be added as a default description for the new concept. Each concept description 16 preferably is unique for the domain to which the concept pertains, although a single concept may appear in multiple domains.

The existence and status of concepts preferably is fluid and subject to change or user modification. For example, while not limited to or necessarily encompassing each of these options, concepts may be added, updated, deleted, retired, or merged.

When updating or otherwise modifying the status of a concept, the system may establish an audit trail of all modifications.

Deleting a concept may require deleting all maps associated with the concept.

Retiring a concept may include removing relationships to that concept and affecting the status for that concept. The status may be modified to reflect the retired status. This status may occupy a row in a table listing each of the concepts.

Instead of deleting or retiring a concept, it may be desirable to merge one or more concepts together. In the event of merging an older concept with a newer concept, the user preferably is able to search for the newer concept. In addition, data associated with the older concept may be re-mapped to the newer concept ID. A row in the concept table for the older concept may be flagged as retired, and a comment may be inserted to reflect that the older concept has been merged with the newer concept.

Conversely, instead of merging concepts, it may be desirable to keep one or more concepts distinct from one another but create a relationship between the concepts. For example, a single concept may be split into one or more additional concepts, and it may be desirable to indicate that the multiple concepts are related. This is achieved by creating and maintaining qualified concept-to-concept relationships, e.g., “is a child of,” “is a parent of,” etc.

In order to keep track of concepts, each concept may be assigned a unique numerical identifier. This identifier may be generated randomly. Alternatively, multiple related concepts may share some commonality in identifiers, e.g., each having the same first three numbers.

Each concept may map to one or more external codes 20 (e.g., a reference, clinical, or administrative terminology), where each mapping indicates both: a) a preferred status and b) a type of relationship in comparison to the external code, e.g., same-as, broader-than, or narrower-than. For example, the concept “acute mastoid sinusitis” may have a preferred map to a SNOMED concept of “acute sinusitis” with a relationship type of “narrower-than,” meaning that the concept being mapped is “narrower-than,” i.e., more specific than, the SNOMED concept. It may be desirable to map the new concept to a reference terminology or to one or more other concepts, either at the time of creation or otherwise.

Clinical interface terminology may use a reference terminology to create or supplement ontology, i.e., relationship among concepts.

### Categories

The system may allow for the creation of categories, which may not be related hierarchically to the other system components. Each category may have one or more concepts mapped to it. Categories may be a sub-domain, e.g., laboratory procedures within a “procedures” domain, or a collection of concepts across sub-domains.

It may be possible to add new categories, delete an existing category, or edit the name of an existing category. New categories may have unique names and may have associated comments. In one embodiment, only the user that creates a category may be allowed to delete that category. In another embodiment, either that user or a user with higher access privileges may be able to delete the category. Deleting a category may result in the deletion of all concepts mapped to that category.

Within a category, the user may be able to add one or more concepts to the category. Conversely, the user may be able to add one or more categories to a concept or to delete a category from a concept.

The system also may allow for the copying of one or more concepts of an existing category to another category or a new category.

The user also may be able to able to add one or more flags to a concept and/or the concept-description mapping. With respect to that mapping, flags may be used to associate the concept with, e.g., a default description, preferred descriptions, consumer descriptions, secondary descriptions, etc. In addition, a flag may be used to indicate whether the concept or one of its descriptions is a lingual variant, e.g., and English/British variant. Flags also may be used to establish search filters and/or display result filters, e.g., only displaying terms relevant to one or more groups of users.

### Descriptions

Descriptions 116 may be a collection of text strings or terms and may represent alternative ways to express a concept, which may allow the system to capture concepts in the terms that various, varied practitioners may use. Multiple descriptions may map to a concept, but each description preferably has the same meaning. For each concept, there may be one or more preferred descriptions. For example, there may be at least one of a preferred clinician and a preferred patient term, in order to capture both clinical intent and an explanation understandable by the lay patient. As discussed above, preferred terms may be called out with the use of flags to the respective entries.

It may become necessary to determine whether a new term is a description within an existing concept or whether it merits the creation of a new concept. This determination may be driven by an iterative, editorial process. Preferably, the determination is based on an understanding of clinical science, such that creation of a new concept results from a clinical understanding of its difference as compared to existing concepts.

Each concept may include a default description, and the system may include an editing module in order facilitate changing this description. A default description may be selected, e.g., by receiving a user selection, and it may be the description that is mapped to a concept and has a CONTEXT_ID equal to some predetermined value, e.g., 1. While descriptions may be deleted, the system may prevent the deletion of a default description, at least until a new default description has been established.

As seen in FIG. 2, multiple descriptions 16 may be associated with each concept 14. Descriptions 16 are associated with lists of words (discussed below). (FIG. 2 further illustrates that each concept may map to one or more external codes, such as an administrative term code 20, a clinical term code 30, and/or a reference terminology code 40.) These words may include the words that map to descriptions 16 from a table such as the DESCRIPTION_WORD_MAP table. They also may include words that map to words in one or more other tables, such as a WORD_GROUP table, which may include other variations around the word, e.g., plural forms and misspellings.

Concepts 14 are unique within a domain, and the same description is not used more than once across all concepts. Thus, the system may allow the user to leverage existing descriptions to form the basis for new descriptions. For example, the system may include a graphical user interface that allows the user to select an existing description within a separate concept and to populate fields relating to the description in the new concept with those from the existing descriptions. Similarly, selecting an existing description within the same concept or a different concept may generate a list of suggested descriptions to be added based on word equivalence. Moreover, instead of copying a description from one concept to another, the system may allow the user to move a description between concepts.

Without context, a description may not provide the user with full understanding of what it represents since the description may be related to multiple concepts. For example, acronyms may be included as descriptions, and while the acronym MI may refer to myocardial infarction or mitral insufficiency, descriptions may be “MI (myocardial infarction)” and “MI (mitral insufficiency),” which may be referred to as disambiguation. Even if the same description is used in multiple concepts, preferably the system includes a separate instance of that description for each concept. For example, two of the concepts shown in FIG. 2 may include the description “MI,” but those descriptions 16 are linked to their own concepts 14, i.e., there is no description that shows a relationship with two separate concepts.

### Words

Words may be a subset within descriptions. Words may reflect variations of the descriptions such as misspellings, alternative spellings, abbreviations, variations in parts of speech (the adjective of a noun description, e.g.), etc.

Words also may include items that are related to, but are not variations of, the descriptions to which they are attached. For example, “heart” may be a word under the description “myocardial infarction.”

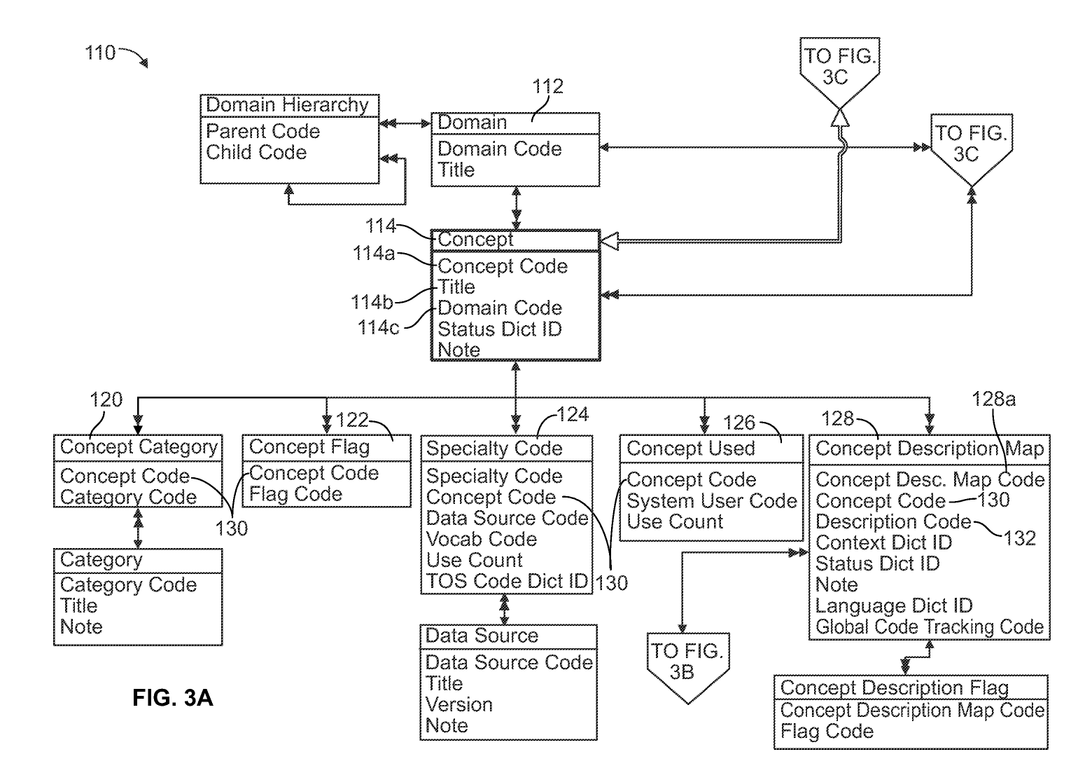

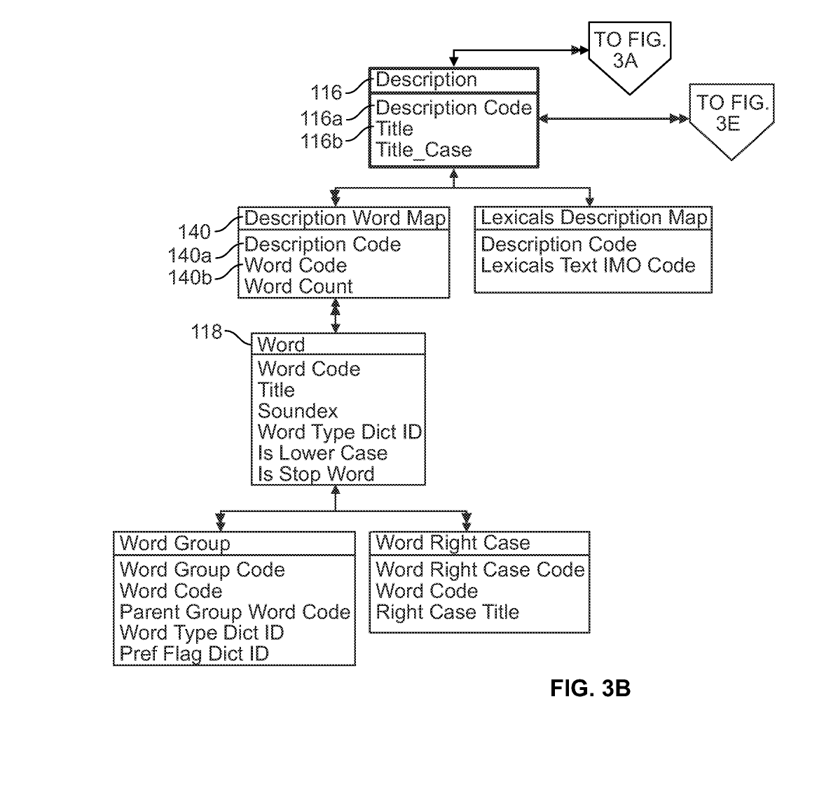

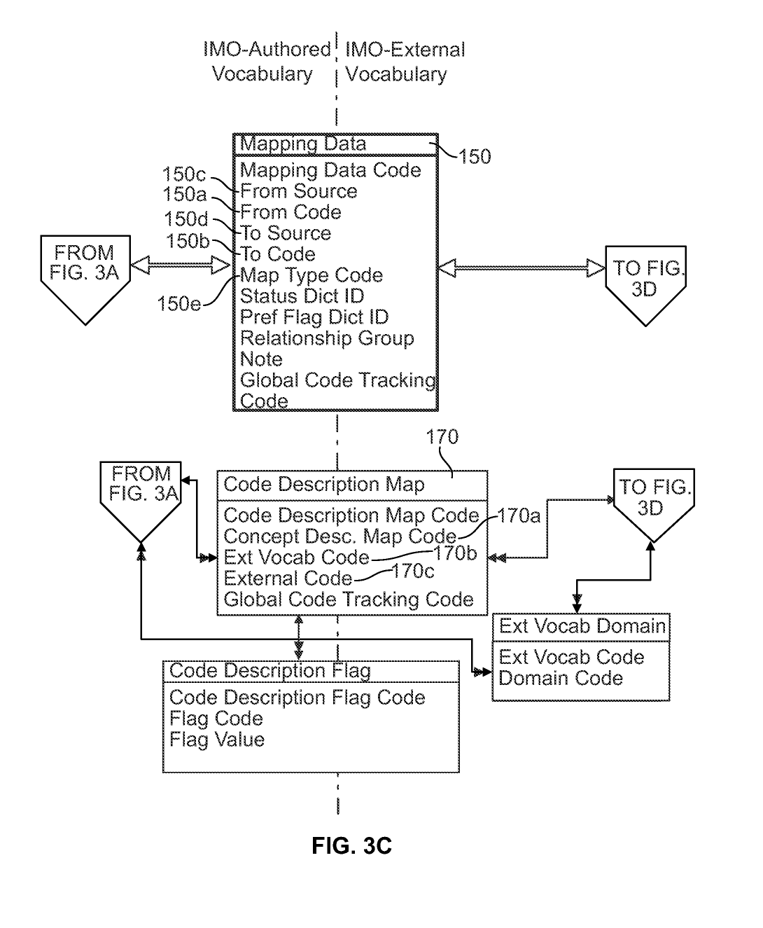

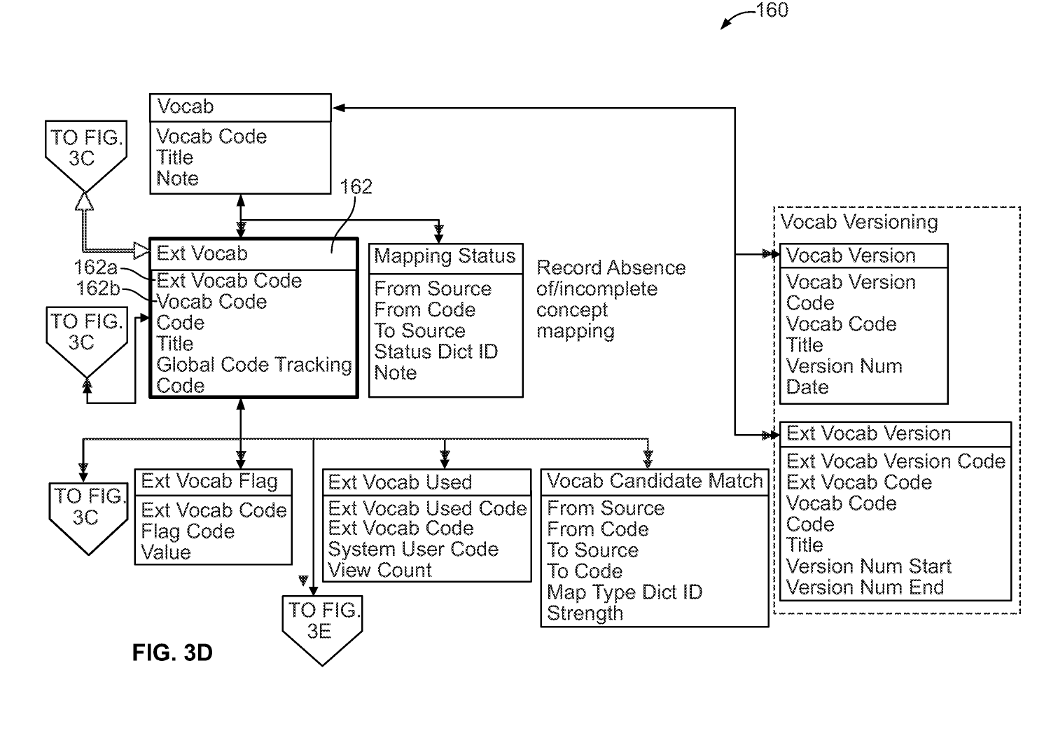

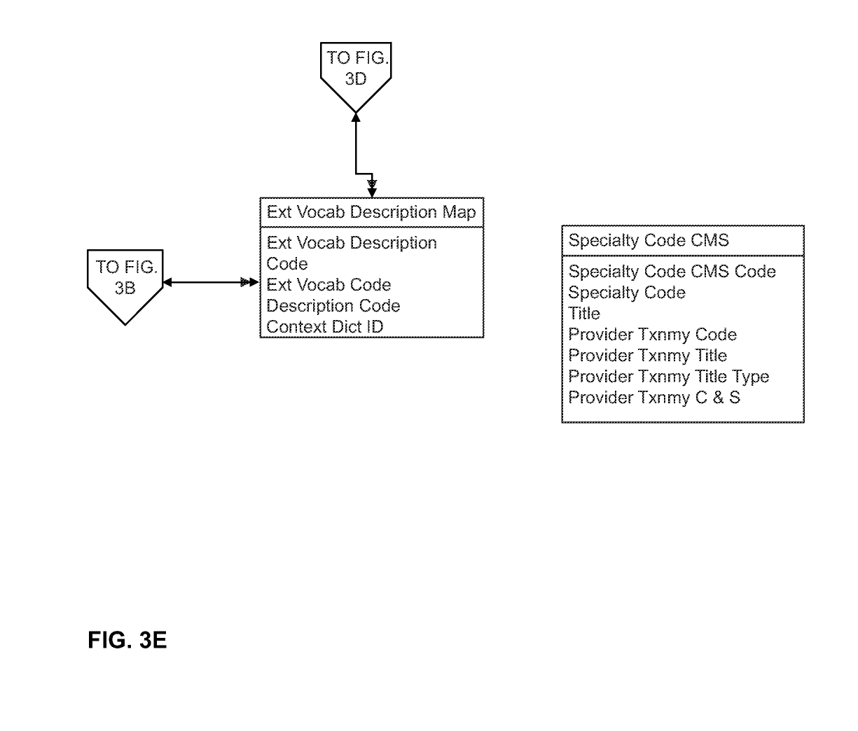

FIGS. 3A and 3B illustrate one example of the relationships between the domain 112, concept 114, description 116, and word 118 component tables of an interface terminology schema 110. The arrowheads in this figure represent the degree of relationship; thus a line with one arrowhead pointing to one table at one end and two arrowheads pointing to a second table at a second end depicts a one-to-many relationship.

As seen in FIG. 3A, each concept table 114 may include an entry in columns representing the concept code 114a, title 114b, and domain code 114c. The concept additionally may include entries in the Status Dict ID and Note columns.

Concept table 114 may link to one or more additional concept-related tables 120, 122, 124, 126, 128. One or more of these tables may include a column containing the unique identifiers for each concept, e.g., “Concept Code” column 130. Concept code column 130 may be identical to or relate back to concept code column 114a, e.g., via the use of one or more foreign keys to refer back to the parent concept table 114.

Similarly as shown in FIGS. 3A and 3B, each description in description table 116 may include entries in at least a description code column 116a and a title column 116b. The schema shown indicates that there may be a table linking the concepts to the descriptions, e.g., the “Concept Description Map” table 128. Within this table, there may be columns for concept codes 130 and description codes 132, as well as a column for a code indicating a map 128a between concepts and descriptions. Because multiple descriptions may map to a single column, entries in the description column preferably are unique, whereas entries in the concept column may be repeated. Alternatively, entries in each of the concept description map code, concept code, and description code columns may be unique, and for each map code entry, there may be pointers to the respective entries in the concept code and description code columns.

Staying with FIG. 3B, similar relationships exist between the description 116 and word 118 tables, with both linking to a Description Word Map table 140 that includes both description code columns 140a and word code columns 140b.

### Interface Terminology

Within this framework, an interface terminology 10 may be created. An interface terminology may be the link between what the clinician wants to say and what the terminology can capture.

Unlike administrative code sets and reference terminologies, which often are stored in the back-end functions like billing, reporting, decision support, research, and interoperability between applications, an interface terminology may operate at the front-end of a clinical information system, i.e., in the “presentation layer.”

The interface terminology may be a suite of vocabulary products that help institutions capture clinical patient information. This interface terminology subsequently may provide access to standardized vocabularies, such as ICD, CPT, SNOMED® CT, MeSH, & UMLS, in order to connect providers and patients with the patient record, administrative information, academic references, and consumer information. As such, an interface terminology may serve multiple ends, including, e.g., capturing a clinician's intent, driving financial aspects including billing, and driving analytical functions.

In one embodiment, an interface terminology may include mappings between concepts and code sets that are configured not to change over time. Alternatively, the mappings between an interface terminology concept and a reference, interface, or other standard code set may be subject to change, e.g., in light of regulatory changes or modifications to those code sets.

A key feature in establishing an effective terminology may be the inclusion of a comprehensive set of descriptions for each concept. Descriptions preferably include both clinician-friendly terms, e.g., vernacular, common terms, abbreviations, acronyms, eponyms, or common misspellings, and patient-friendly-terms.

### Relationship to Electronic Medical Record

The present system may be integrated within an EMR, see, e.g., commonly owned U.S. Pat. No. 8,589,400, titled “Longitudinal Electronic Record System and Method,” the contents of which are incorporated by reference, such as by linking external codes with interface terminology related to data in the various instances within a medical record.

The system also may be separate from the EMR, and the EMR may access the terminology as an external service.

A patient's medical record may include multiple domains of terminology, including, e.g., problems, plans, procedures, observations, histories, allergies, medications, etc. Each of these domains will include sets of concepts that may be mapped internally to other concepts and externally to other codes or source vocabularies.

Unique concepts may belong to, at most, one domain. Domains may be divided into sub-domains. In one embodiment, concepts map to external code sets. For example, problem concepts may map to administrative code sets, such as: ICD-9-CM, ICD-10-CM, ICD-10-WHO, ICD-10-CA. Procedure concepts may map to administrative code sets, such as: CPT, ICD procedures, and HCPCS. Observation concepts (including, e.g., lab results) may map to LOINC. Other external source vocabularies for mapping may include, but not be limited to, e.g., UMLS Metathesaurus, NCI Thesaurus, NDC or other drug terminologies or codes, nursing terminologies such as NIC, NOC, NANDA, CCC (previously known as HHCC), and PNDS.

Alternatively, it may be possible to map concepts in multiple domains to one external code set. For example, all interface terminology concepts across multiple domains may map to respective SNOMED concepts.

Concepts may include work flow aspects. For example, concepts may be orderable, performable, resultable, chargeable, and/or historical. (Concepts are flagged as one or more of these aspects, e.g., procedure terms may be used in multiple contexts.) Each of these aspects may relate to external coding or terminology, and the present system and method may link this coding or terminology together.

### External Code Mapping

In the past, descriptions may have been mapped to respective codes in external code sets individually. Multiple descriptions may have mapped to a single external code, but those descriptions may not have had the same meaning

Here, conversely, each description 16 in the interface terminology 10 preferably maps to a concept 14, and that concept 14 is mapped once to the respective codes in the external code sets 20, 30, 40, as seen in FIG. 2. As such, the underlying descriptions may be subject to additions, deletions, or other modifications, while the higher-level concept linking remains intact.

In addition to user-generated matches between system concepts and external codes, the system may populate a list of potential match candidates, e.g., based on word equivalency that meets or exceeds a predetermined or user-defined threshold.

Concepts are related to external code sets using qualified relationships—a relationship type—including: exact match, broader than, narrower than, related to, equivalent to, has-location, has-severity, has-laterality, etc. Other relationship types may include: “due to,” “associated with,” “has morphology,” “has causative agent,” “has associated finding,” “has laterality,” “has associated procedure,” “has location,” “has direct evidence,” “has direct substance,” “has focus,” “has interpretation,” and “interprets.” This relationship coding may provide more granular and complete relationships, which may provide a more accurate mapping.

Preferably, the interface terminology concepts are at least as specific as the external codes. In the event that an interface terminology concept is broader than a more-specific external code, that interface concept may map to one or more of the more specific external codes. Alternatively, a newer, more specific interface terminology code may be created, in order to respond to clinical care use cases

In a significant majority of cases, the interface terminology concepts may be more specific (more granular) than those of the external code sets. In that case, those concepts may map to the next highest, most accurate external code.

Multiple external code set codes further may be related to a distinct concept according to varying degrees of preference, e.g., primary preferred, primary non-preferred, secondary preferred, or secondary non-preferred.

As shown in FIG. 2, one concept 14 may map to multiple external codes 20, 30, 40. Additionally, multiple concepts may map to a single external code. The system may include a preferred base code mapping flag that indicate the optimal external code for a given description and, conversely, a preferred description code mapping flag that indicates which description is preferred for display of a given external concept.

One or more descriptions may be copied from a first concept to a second concept that is part of a different domain. Similarly, code mappings from one concept may be cloned to pertain to a second concept, and the system may permit the user to select which codes to copy.

The system and method may allow for a large degree of flexibility in mapping. For example, it may be possible to map to external codes that include laterality (e.g., one code for a problem relating to the right kidney and a second code for a problem relating to the left kidney). Additionally, the system and method may map to codes that reflect combinations (e.g., Crohn's disease of small intestine with fistula) and codes that reflect a recordation of the episode of care (initial visit vs. follow-up, etc.).

External code sets may be updated or modified fairly regularly, e.g., one or more times a year for most sets and up to weekly or even daily for drug vendor data. This system and method may process these updates in a back-end environment, such that users may continue to use the same terminology, unaffected by these updates.

Data may be stored in one or more databases, e.g., object-oriented or relational databases. Mapping, as well as the ultimate packaging of the mapped relationships into an end-user format as described below, may occur on one or more computers via one or more processors. In addition, while the data structure described herein reflects entries in columns within one or more tables, this should be understood to encompass a data structure with the categories entered in rows.

Returning to FIGS. 3A, 3B, and 3D, this external mapping may be represented by the creation of a Mapping Data 150 table that links the Concept table 114 on the Interface Terminology side and the Ext. Vocab table 162 on the External Vocabulary side 160. As with the mappings between concepts 114 and descriptions 116, described above, where there is a column for concept codes and description codes, the Mapping Data table 150 may include columns for a “From Code” 150a and a “To Code” 150b, e.g., an interface terminology code and an external vocabulary code, respectively. In addition, because there may be multiple domains storing concepts and multiple external code sources, the table also may include columns with entries identifying a “From Source” 150c and a “To Source” 150d. The mapping table also may include a Map Type column 150e, which may provide additional information regarding the mapping, e.g., whether the mapping is primary preferred, primary non-preferred, secondary preferred, or secondary non-preferred.

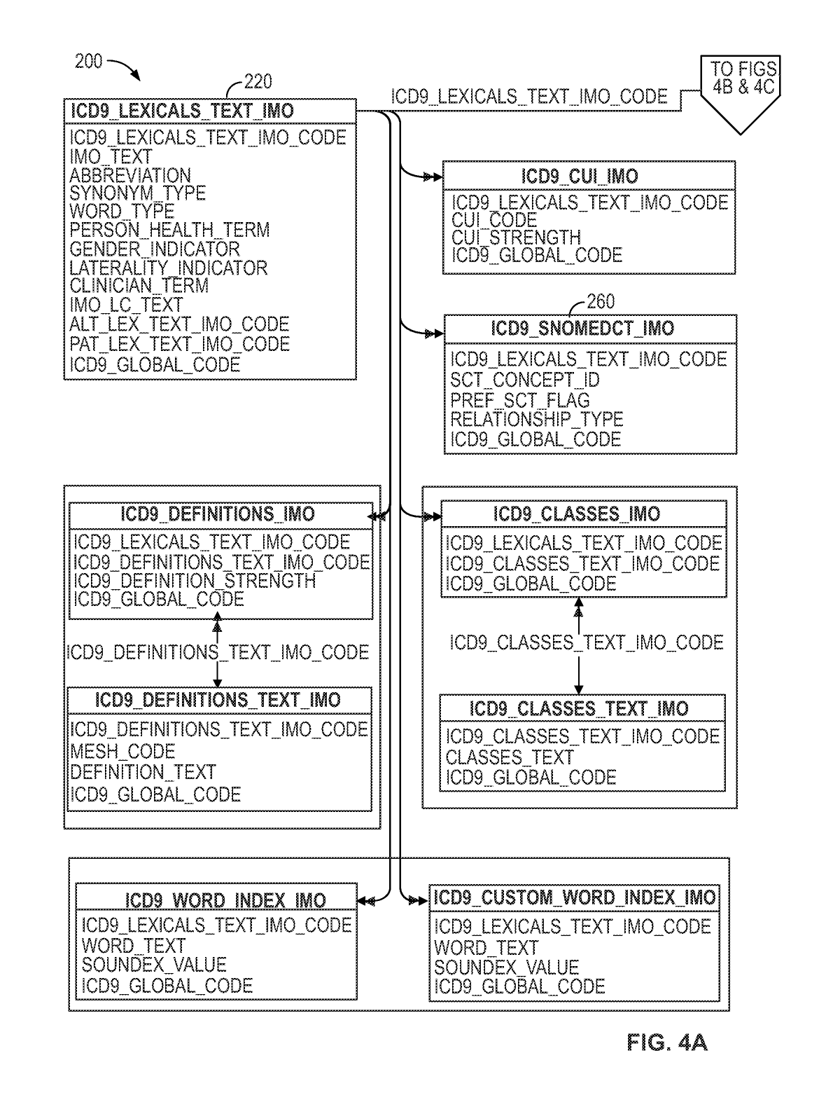

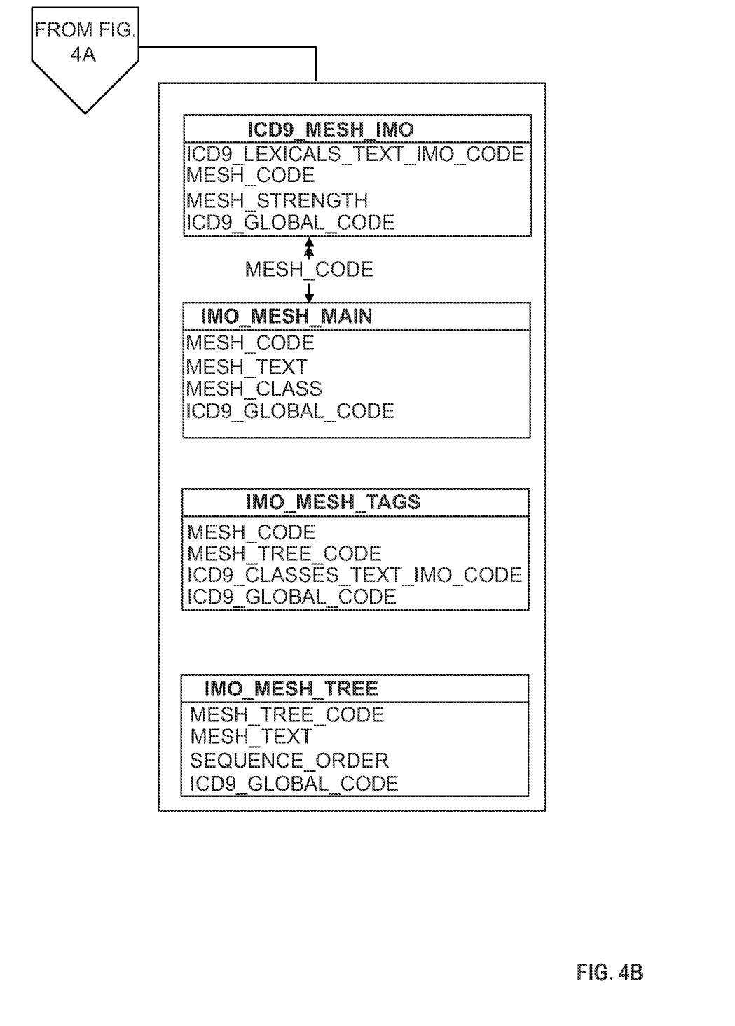

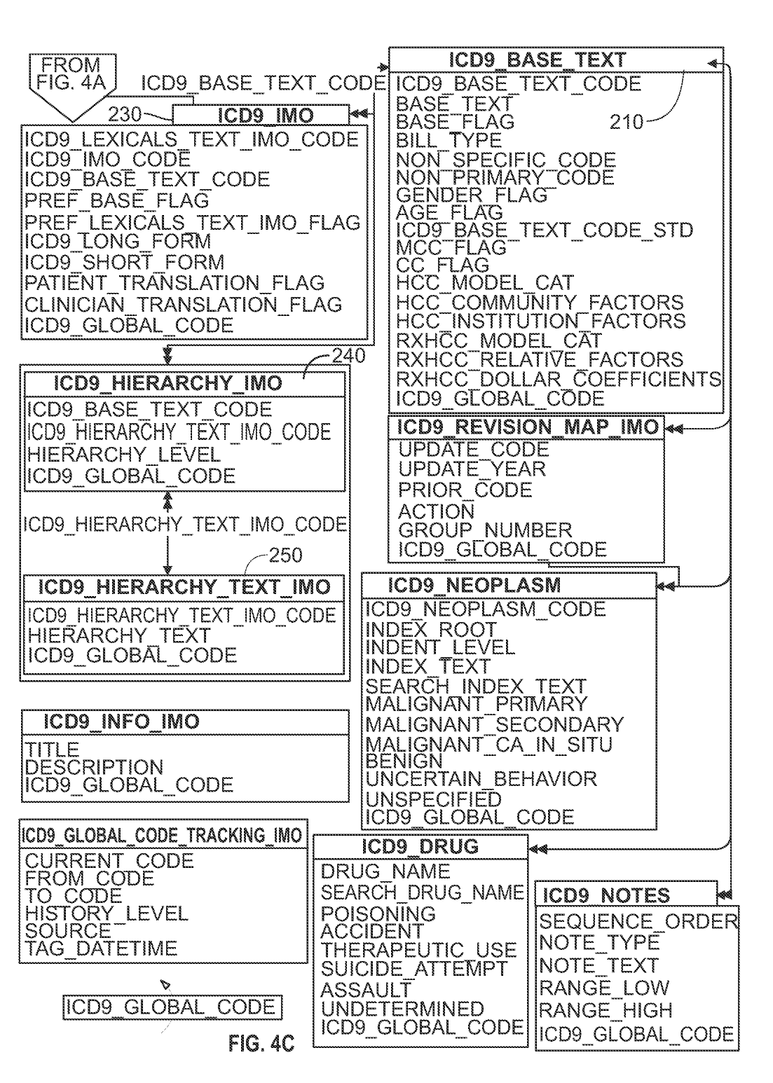

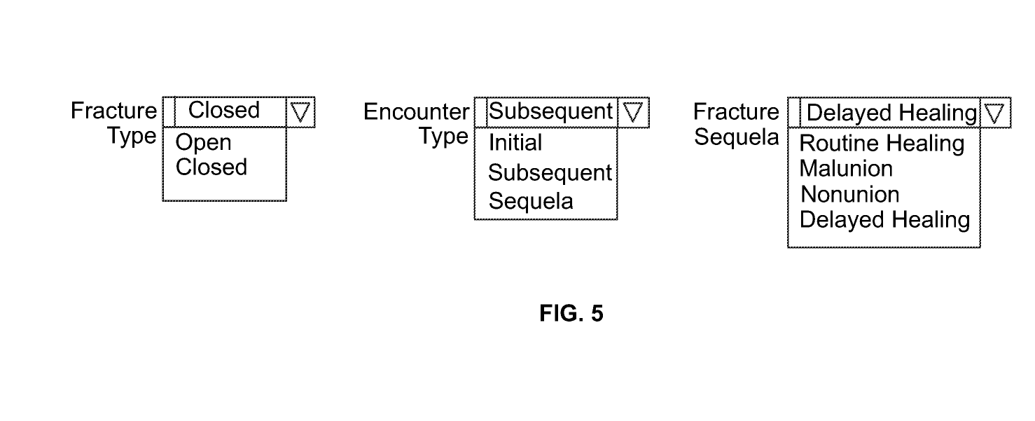

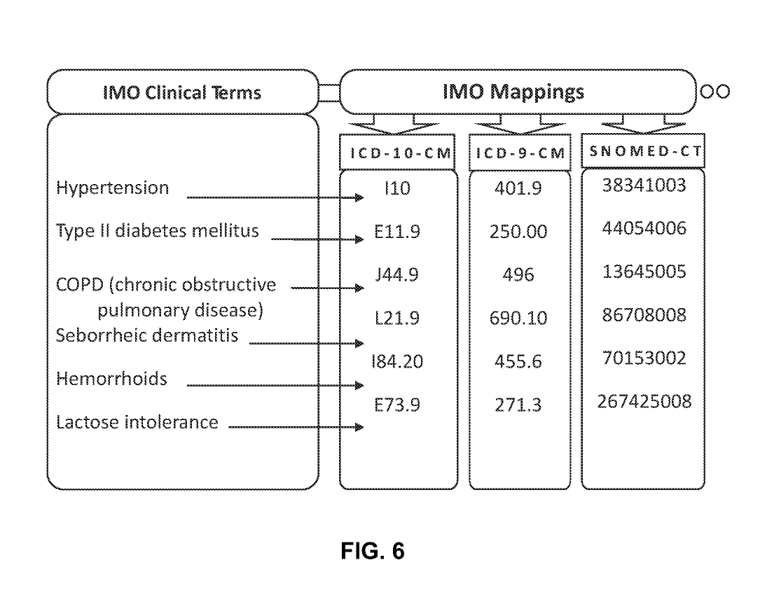

FIG. 4 shows a distribution entity relationship diagram 200 illustrating the relationship between one external code set (here, ICD-9) and the interface terminology. FIG. 4 may not represent a true back-end data structure, such as the one shown in FIG. 3, but instead may reflect how the data may be presented or perceived as a result of a software build from FIG. 3.

Table ICD9_BASE_TEXT 210 may contain the codes and full textual descriptions of the ICD-9 external code. It also may contain a plurality of entries and/or flags for additional information that may be useful with the external code, e.g., ability to bill, code specificity, ability of code to be used as primary diagnosis, gender indicator/flag, and age indicator/flag.

Table ICD9_LEXICALS_TEXT_IMO 220 may include codes and related textual entries for interface terminology descriptions/lexicals.

Linking these tables, table ICD9_IMO 230 may map the interface codes and texts to the external codes and texts in a many-to-many relationship. This table also may include flags to determine preferred codes for each relationship. It also may include flags for the following entries: a match to the external code full description; a truncated short description; a patient translation flag (flagging a preferred patient description); a clinician translation flag (indicated preferred physician description for a given external code); a preferred base code mapping, which indicates an optimal external code for a given description; and a preferred lexical/description code mapping.

In order to manage data, a system and method such as disclosed in the co-owned U.S. Pat. No. 6,904,432, titled “Adaptive Data Manager,” and/or U.S. Pat. No. 7,693,917, titled “Method for Adaptive Data Management,” may be useful, the contents of both of which are incorporated by reference. For example, elements of the interface terminology and their relationships, as well as relationships with the external code sets, can be captured and managed using a directed graph data structure in a back-end information storage infrastructure.

Other tables in this structure may include a hierarchy table such as ICD9_HIERARCHY_IMO 240, which contains clinical hierarchical designation of each code. There may be multiple levels of designation indicated by the HIERARCHY_LEVEL column in the table. Each external code may have at least one entry in this entity. In one aspect, the actual text for this table may be stored in a separate, linked table, such as ICD9_HIERARCHY_TEXT_IMO 250.

Another significant table may be represented by the ICD9_SNOMEDCT_IMO table 260 of FIG. 4. This table may contain a mapping between interface terminology description terms and external code concept terms. Each description may have one or more maps, although the table may include preferred flags and relationship flags to allow for a one-to-one mapping, if necessary.

### Interface Terminology

Turning to FIG. 7, one example of an interface terminology code set may include about 400,000 codes. These codes may map to the sample code set 320 selected for analysis, e.g., ICD-9-CM, which may include about 10,000 elements. As stated above, these codes then may map to the 500 or so DRGs 340. One interface terminology code element may map to more than one DRG, and each DRG may include multiple mapping interface terminology code elements. As such, interface terminology elements and DRG elements may exist in a many-to-many relationship with one another, i.e., one interface term may relate to many DRGs and one DRG may relate to many interface terms.

FIG. 7 describes one way in which clinician data input ultimately can be used to accomplish the desired DRG analysis.

One method of determining a relationship between interface terminology code elements and DRG entries may be to map sample code set elements to those interface terminology code elements 320, pass the sample code set entries to the medical record department or, more accurately, to a DRG encoder 330, return the possible DRG code or codes, and then build a map of interface code elements to possible DRG codes. Another method may be less concerned with an identity of the possible DRG codes and more concerned simply with whether or not one or more possible DRG code matches exist. In that case, the system may return either the possible DRG code(s) or an indicator as to whether or not one or more possible DRG code matches exist for the input patient data. Because there may be one or more DRG codes that correspond to invalid or insufficient information, insufficient information to determine a DRG code match means that there is not enough information entered to determine any DRG other than the invalid/insufficient information codes.

Several factors may complicate this basic method. For example, a single sample code element may not provide sufficient information to generate a DRG, which may prevent a simple one-to-one mapping from interface or sample code elements to DRGs.

In addition, even though the mapping is many-to-many, an interface terminology or sample code set element may map to one DRG in one instance and a second DRG in a second instance. One reason for these different outcomes may relate to the consideration of patient comorbidities—secondary diagnoses—and age and gender.

Moreover, the reason for the patient stay may matter in determining which DRG is returned. For example, if it was a surgery event, the ICD-P will matter first for establishing the final DRG, otherwise primary and secondary ICD-9-CM codes will drive DRG determination.

In order to address these various concerns, a permutational analysis 350 may be performed to determine the possible DRGs, if any, that may result from one or more sample code set entries. Thus, for the data entered by a clinician, matching interface terminology elements may be determined 310. From there, existing maps to respective sample code set elements may be used to determine which sample code set element(s) apply 320. The sample code set may include separate entries for varying levels of severity of a condition encoded within the code set or may include flags for one or more elements that can be turned on or off to provide an indication of severity.

The permutations of the set of sample code set elements 350 may be communicated to the DRG encoder 330 to determine if enough information has been entered to generate one or more possible DRGs, and a result of that query may be passed back from the encoder 340, where the result may be in the form of a number of or the identities of relevant DRGs.

In one aspect, it may be possible to reduce the number of permutations that require analysis by relying upon the interface terminology elements that are mapped to the sample code set elements. Interface terminology elements may include a plurality of concepts within one or more subject matter domains. There may be one or more descriptions that map to each concept, where each description reflects an alternative way to refer to the concept, i.e., the descriptions may reflect a user's clinical intent. As such, it may be possible to cluster one or more permutations together based on clinical intent. Once clustered, it then may be possible to analyze the smaller group of permutations 350 for the presence of a DRG match, thereby reducing computational time and increasing system efficiency.

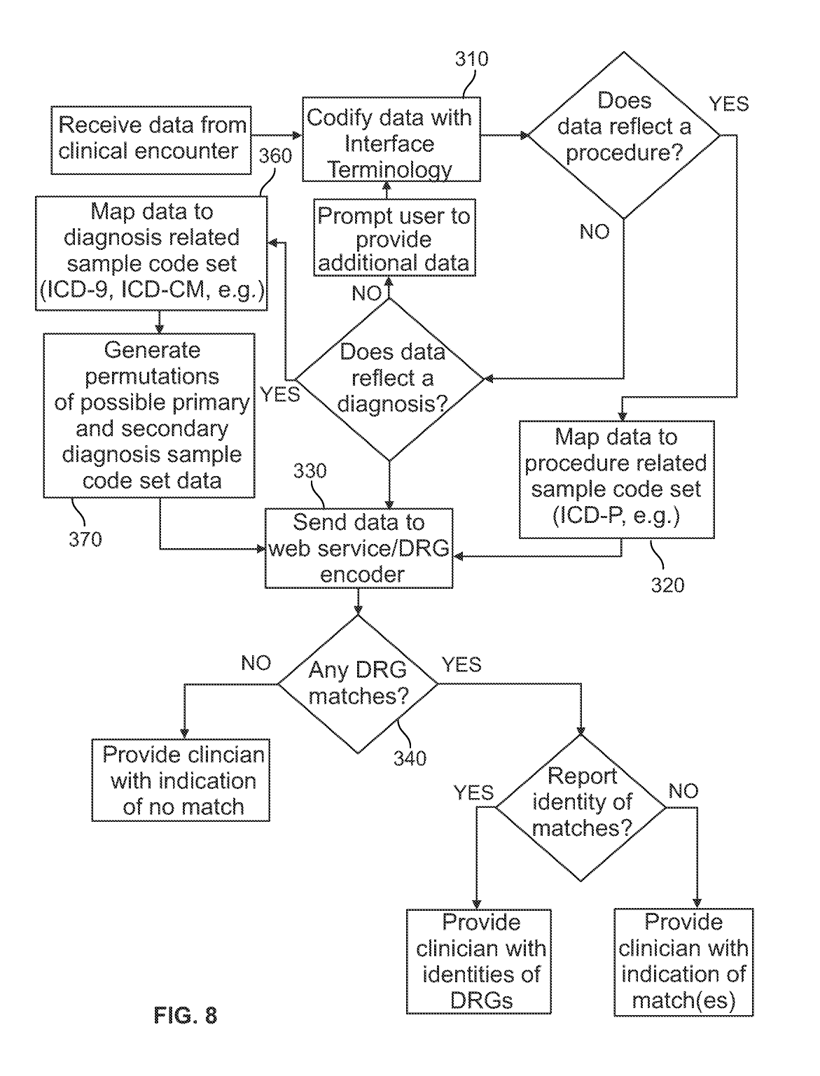

Turning to FIG. 8, in another, preferred aspect, reduction in the number of permutations that require analysis may be accomplished by reducing the number of sample code set elements that go into a permutation. This procedure may be accomplished in one or more ways. For example, determining the reason behind the patient's visit may be important because it may influence the code set used and/or the number of sample code set elements used. Procedures, e.g., inpatient procedures, may be codified using elements from an ICD-P or ICD-10-PCS code set, whereas diagnoses may be codified with ICD-9-CM, or ICD-10-CM codes.

Still further, it may be possible to reduce the number of codes within each set that are used. For example, a typical diagnosis scenario may result in primary and secondary diagnoses being made. Thus, instead of considering all possible permutations within the code set, it may be necessary only to consider whether a certain pair from the set of possible pairs provides enough information to generate a DRG. In other words, for “n” possible code elements, instead of n! possibilities, there may be n!/(n−r)! possibilities; and when r=2 because pairs are being considered, this means the system only may need to analyze n*(n−1) possibilities.

From a workflow standpoint, in another aspect, the method may include receiving clinician inputs relating to a patient's problem list. Clinicians may enter terms or phrases using their clinical intent. Each term or phrase may correspond to an interface terminology description within a domain, and that description may map to a respective concept 310. (Note that descriptions and concepts both may be unique within a given domain.) Those interface terminology elements then may map to respective sample code set elements, which may be sent to the DRG encoder.

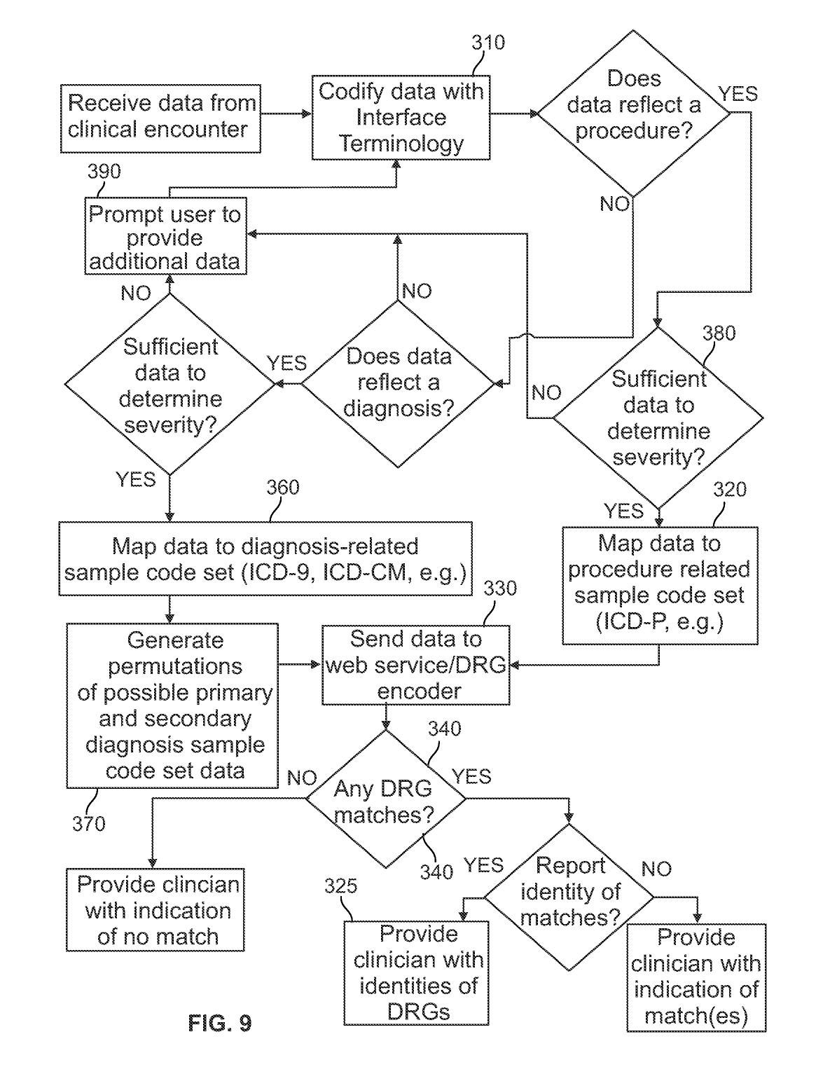

As discussed above, there may be different DRGs for similar procedures or diagnoses, differing, e.g., in the severity of the procedure or condition. As it relates to the sample code sets, severity may be reflected in the choice of code set element selected. Alternatively, in the case of primary and secondary diagnoses, the secondary diagnosis code may serve as an indicator of severity of the event associated with the first diagnosis code. Thus, turning now to FIG. 9, it also may be beneficial to determine whether the user has entered enough information 390 to determine a severity either of the potential procedure or potential diagnoses that may be recorded. If not, the system may prompt the operator to provide additional information sufficient to make this determination. The system may include a series of interactive questions or prompts that may seek to drive the clinician towards interface terminology elements that relate to specific sample code elements, as certain code values or combinations of code values may more closely relate to DRG entries, thus helping to ensure that sufficient information for at least one DRG has been entered. The interactive questions may recognize that certain sample code elements may correspond to one of a handful of other sample code elements that are tied more directly to DRG findings, and the system may attempt to determine which of those other sample code elements, if any, are equally if not more applicable.

Once an interface terminology 310 description (and, thereby, a concept) has been determined, a mapping to a sample code 360 set element may be generated. In one embodiment, a preferred primary mapping may be generated along with a preferred secondary mapping 370. This procedure then may be repeated for each item entered by the clinician, until a list of sample code set 370 elements is generated.

As seen in any of FIGS. 7-9, after the code set elements are generated, they then may be fed into a DRG encoder 330, which will analyze the elements and determine whether sufficient information has been entered to generate at least one possible DRG match 340.

A DRG may include elements detailing a severity of the patient's condition, which among other things, may affect a level of reimbursement and also may affect the sample code set element that is applicable. By being able to capture clinical intent using the interface terminology elements, the system may be able to capture these details at the outset. In addition to helping to ensure that enough data for at least one DRG is captured, this also may help assure that the proper DRG is captured at the outset. As such, the system may minimize or eliminate the problem of a coder needing to go back to the clinician for more information or for clarification.

The DRG matches may be conveyed back to the clinician 325. As a result, clinicians may benefit from real-time feedback in order to see how their diagnoses score on various scales, e.g., a morbidity index, a severity of illness index, and/or a mortality index. In this alternative, the clinician may be able to visualize resulting DRG match(es) as the clinician captures his/her clinical intent by entering one or more interface terminology terms in the patient's health record As such, the real-time feedback may alert the clinician either to the fact that sufficient information to determine one or more DRGs has been entered or to the fact that additional data entry is required.

Preferably, however, the clinician may receive only an indicator as to whether or not sufficient information has been entered to determine a potential DRG and, if so, how many potential DRG matches may exist. In this way, the system may avoid occurrences of “upcoding,” in which a practitioner selects a DRG with a larger possible insurance reimbursement value, whether it is the best-suited DRG or not.

The system may include a series of tiers, each tier carrying out its own functions. As seen in FIG. 4, a first tier may include a core service 400 or API, which may serve as a centerpiece for content-based computations. A machine-readable document, such as an XML document or more specifically a patient Clinical Document Architecture (CDA) document or Continuity of Care Document (CCD) 440 containing the sample code set data may be transmitted to the service for analysis.

The core service 400 may be a stateless, software-as-a-service solution, which may permit it to be hosted on and processed by a processor on the clinician's machine, a computer in the medical records department, and/or an off-site, third-party computer. In one embodiment, the first tier service may serve one or both of the interface terminology data and the DRG data. Providing these data sources in a stateless service may be beneficial by permitting them to be updated and kept current without a need to update them across multiple clinicians' computers, across multiple heath care organizations, etc.

The first tier may include the DRG encoder 330 in order to determine whether and how many DRG matches exist for the given sample code set information.

The first tier API/core service 400 may be called multiple times per patient interaction, e.g., for data validation. For example, each time the clinician enters additional data, the API 400 may be called to determine which interface terminology code elements correspond to the clinician's entries. In addition, the API may be called to implement the DRG encoder 330, with results being sent back to the clinician or other caller UI.

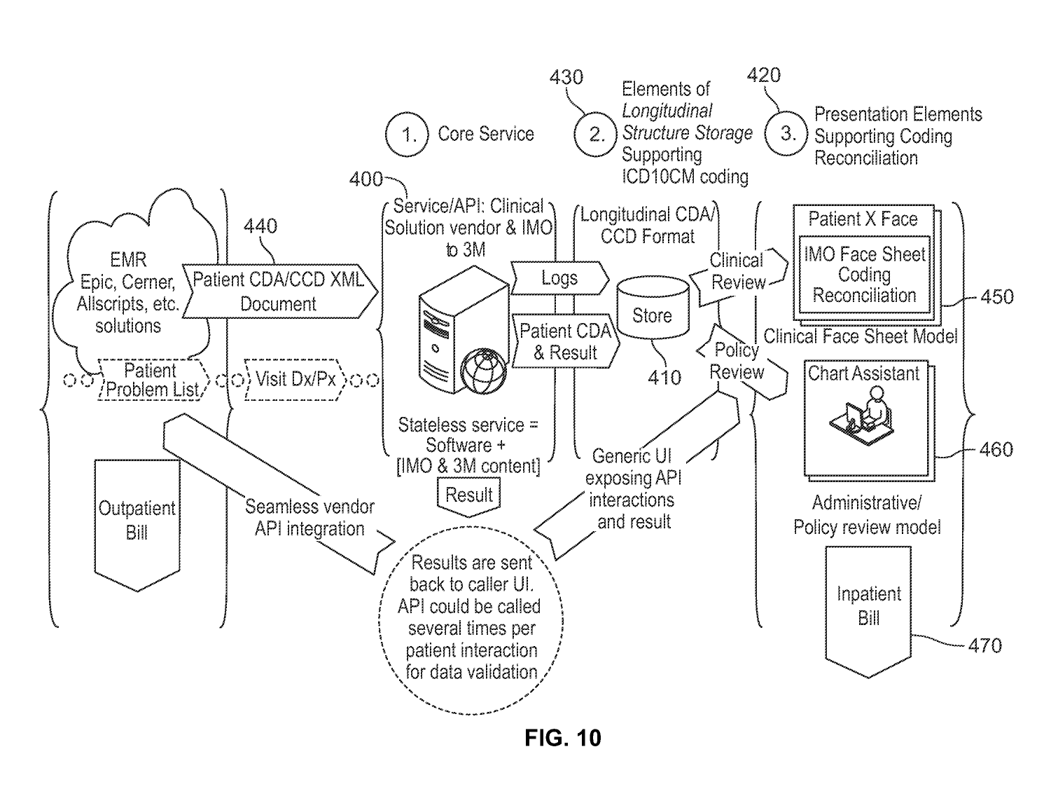

Returning to FIG. 10, a second tier 430 may include a data store that may be configured to gather interaction logs and patient transactions. The data store 410 also may be configured to receive the patient data file and the results of the API 400 calls. In one embodiment, this data store 410 may permit the creation of a query result database. Instead of calling the first tier API 400, that database may be searched in future transactions, which may permit faster, more efficient future analysis.

A third tier 420 then may include both clinical and administrative user interface parts in order to review and to administer transactional data. One element of this tier may include a face sheet 450 that permits coding reconciliation, e.g., determining that a proper code has been attributed as a primary diagnosis and that an acceptable secondary diagnosis also has been recorded. Put another way, reconciliation may be performed to make sure that the right information was entered or that the practitioner entered exactly what it was he or she was trying to enter, i.e., that the record actively reflects the practitioner's clinical intent. This tier 420 also may include an interface for chart assistant policy review 460, which may allow the hospital to make sure that its internal coding matches up with that used by the reimbursement entity.

As mentioned above, the method may not display the identity of the DRG or DRGs that match the data entered by the clinician. As such, the third tier 420 may present the data entered by the clinician (and/or the corresponding sample code set information or interface terminology information) and the resulting potential DRG matches to another user for a determination of the proper DRG to apply to the patient visit. That DRG then may be used to generate an inpatient bill 470, including an indication of the portions covered or reimbursable by insurance.

While the foregoing written description enables one of ordinary skill to make and use the same, those of ordinary skill also will understand and appreciate the existence of variations, combinations, and equivalents of the specific exemplary embodiments and methods disclosed herein. The claims should therefore not be limited by the above described embodiment and method but should be interpreted within the scope and spirit of the invention as claimed.

What is claimed is:

1. A method for determining a sufficiency of data entry in an electronic health record, comprising:
receiving a packet of input data from a user, the input data reflecting patient problem, history, or diagnosis information;
linking data elements in the packet with interface terminology data elements using a computer configured to map the patient problem, history, or diagnosis information to one or more external codes;
mapping the interface terminology data elements corresponding to the linked data elements to data elements in a code set using the computer;
sending the mapped data elements in the code set to a service selected from the group consisting of DRG encoder and DRG web service; and
receiving a determination of whether sufficient information has been entered to generate at least one DRG that corresponds to the mapped data elements.

2. The method of claim 1, further comprising:
reporting results of the receiving a determination step to the user.

3. The method of claim 2, wherein the reporting step comprises providing the user with an identification of the at least one corresponding DRGs.

4. The method of claim 2, wherein the reporting step comprises not providing the user with an identification of the at least one corresponding DRGs.

5. The method of claim 1, wherein the user is a clinician evaluating a patient.

6. The method of claim 1, wherein the code set is an ICD-9-CM code set.

7. The method of claim 1, wherein the sending step further comprises:
generating each permutation of the mapped data elements in the code set; and
sending a plurality of the permutations to a service selected from the group consisting of DRG encoder and DRG web service.

8. The method of claim 7, further comprising:
sending fewer than all of the permutations to a service selected from the group consisting of DRG encoder and DRG web service.

9. The method of claim 1, wherein the interface terminology data elements capture a clinical intent of the user.

10. The method of claim 1, wherein there is a many-to-many relationship between interface terminology data elements and DRGs.

11. The method of claim 1, further comprising:
alerting the user if the packet of input data is insufficient to yield at least one DRG in the receiving step.

12. The method of claim 1, wherein at least one of the linking, mapping, sending, and receiving steps is executed by a remotely-located or locally-located software-as-a-service solution.

13. A method for determining a sufficiency of data entry in an electronic health record, comprising:
receiving a packet of input data from a user, the input data reflecting patient problem, history, or diagnosis information;
linking data elements in the packet with interface terminology data elements using a computer configured to map the patient problem, history, or diagnosis information to one or more external codes;
mapping the interface terminology data elements corresponding to the linked data elements to data elements in a code set using the computer;
processing the mapped data elements in the code set to determine permutations of code set elements;
reducing the number of permutations determined in the processing step;
sending the reduced number of permutations to a service selected from the group consisting of DRG encoder and DRG web service; and
receiving a determination of whether sufficient information has been entered to generate at least one DRG that corresponds to the mapped data elements.

14. The method of claim 13, wherein the reducing step comprises:
analyzing the permutations, using the interface terminology data elements mapped to the linked data elements, to determine whether a relationship exists between the interface terminology data elements; and
eliminating permutations where no relationship exists.

15. The method of claim 14, wherein the relationship is based on a clinical intent behind each data element.

16. The method of claim 13, wherein the permutations comprise pairs of code set elements.

17. The method of claim 13, further comprising:
reporting results of the receiving a determination step to the user.

18. The method of claim 17, wherein the reporting step comprises providing the user with an identification of the corresponding DRGs.

19. The method of claim 17, wherein the reporting step comprises not providing the user with an identification of the corresponding DRGs.

20. The method of claim 13, wherein at least one of the codifying, mapping, sending, and receiving steps is executed by a remotely-located or locally-located software-as-a-service solution.
